(19) United States
(12) Patent Application Publication
(10) Pub. No.: US 2015/0199004 A1
(43) Pub. Date: Jul. 16, 2015

(54) SYSTEM AND METHOD FOR HEADGEAR DISPLAYING POSITION OF MACHINE IMPLEMENT

(71) Applicant: Caterpillar Inc., Peoria, IL (US)

(72) Inventors: Lonny E. Johnson, Peoria, IL (US); Michael D. Braunstein, Washington, IL (US)

(73) Assignee: Caterpillar Inc., Peoria, IL (US)

(21) Appl. No.: 14/154,603

(22) Filed: Jan. 14, 2014

(51) Int. Cl. G06F 3/01; G02B 27/01; B60R 1/00

(52) U.S. Cl. CPC G06F 3/013; B60R 1/00; G02B 27/017; G02B 2027/0181; G02B 2027/0178

(57) ABSTRACT

A system is disclosed. The system includes a headgear to be worn by an operator of a machine. The headgear includes a tracking sensor configured to generate a signal indicative of a direction of view of the operator, and an image capturing device configured to generate an image feed indicative of a field of view of the operator. The tracking sensor and the image capturing device are communicably coupled to a first controller. The first controller is configured to receive a signal indicative of a current position of the implement of the machine. The first controller is also configured to overlay a first outline of the current position of the implement onto the field of view based on the direction of view of the operator. The first controller is further configured to display the first outline on the headgear.

### TECHNICAL FIELD

The present disclosure relates to a system and method for displaying machine information, and more particularly to the system and method for displaying the position of a machine implement.

### BACKGROUND

A machine operational on a worksite includes an implement, such as a blade, bucket or ripper, for performing various tasks on the worksite. Sometimes, an operator seated in an operator cabin of the machine may not have a clear vision of specific parts of the implement from the operator cabin. For example, in a track type tractor a cutting edge may not be visible to the operator. This may happen when the machine is performing a digging operation and the cutting edge is partially embedded within the ground. Sometimes, other components of the machine itself may pose as an obstruction in viewing the cutting edge. For example, when the bucket faces away from the operator, the cutting edge of the bucket may not be visible to the operator.

Also, in large machines the operator cabin may be placed higher off the ground. While operating the implement the cutting edge may run below the operator cabin and therefore may not be visible to the operator. Furthermore, in some machines where a power system associated with the machine is located in front of the operator cabin, the view of the cutting edge may be obstructed by the front of the machine.

It may be helpful for an operator to be aware of a position of the cutting edge of the implement for better machine performance. In some situations the operator may need to know the position of the cutting edge to ensure that the cutting edge does not interfere or damage a component of the machine. For example, during operation, if the cutting edge is brought too close to a frame of the machine, the cutting edge may damage the wheels or other machine components.

U.S. Pat. No. 8,139,108 discloses a simulation and control system for a machine. The simulation and control system may have a user interface configured to display a simulated environment. The machine simulation and control system may also have a controller in communication with the user interface and a remotely located machine. The controller may be configured to receive from the machine real-time information related to operation of the machine at a worksite. The controller may also be configured to simulate the worksite, operation of the machine, and movement of a machine tool based on the received information. The controller may further be configured to provide to the user interface the simulated worksite, operation, and movement in the simulated environment.

### SUMMARY OF THE DISCLOSURE

In one aspect of the present disclosure, a system for displaying a position of an implement of a machine is disclosed. The system includes a headgear configured to be worn by an operator of the machine. The headgear includes a tracking sensor. The tracking sensor is configured to generate a signal indicative of a direction of view of the operator. The system further includes an image capturing device. The image capturing device is configured to generate an image feed indicative of a field of view of the operator. A first controller is communicably coupled to the tracking sensor and the image capturing device. The first controller is configured to receive a signal indicative of a current position of the implement of the machine. The first controller is also configured to overlay a first outline of the current position of the implement onto the field of view based on the direction of view of the operator. The first controller is further configured to display the first outline on the headgear.

In another aspect of the present disclosure, a method for displaying a position of an implement of a machine is disclosed. The method includes receiving a signal indicative of a current position of the implement of the machine. The method also includes overlaying a first outline of the current position of the implement onto a field of view of an operator based on a direction of view of the operator within an operator cabin of the machine. The method further includes displaying the first outline on a headgear worn by the operator.

In yet another aspect of the present disclosure, a headgear for an operator of a machine is disclosed. The headgear includes a tracking sensor. The tracking sensor is configured to generate a signal indicative of a direction of view of the operator. The headgear further includes an image capturing device. The image capturing device is configured to generate an image feed indicative of a field of view of the operator. The headgear further includes a first controller communicably coupled to the tracking sensor and the image capturing device. The first controller is configured to receive a signal indicative of a current position of the implement of the machine. The first controller is also configured to overlay a first outline of the current position of the implement onto the field of view based on the direction of view of the operator. The first controller is further configured to display the first outline on the headgear.

Other features and aspects of this disclosure will be apparent from the following description and the accompanying drawings.

### BRIEF DESCRIPTION OF THE DRAWINGS

FIG. 1 is a perspective view of an exemplary machine, according to one embodiment of the present disclosure;

FIG. 2 is perspective view of an operator seated within an operator cabin of the machine of FIG. 1, the operator wearing a headgear;

FIG. 3 is a block diagram of a first configuration of a system for displaying a machine information, according to one embodiment of the present disclosure;

FIGS. 4, 5 and 6 are exemplary perspective views of an interior portion of the operator cabin as seen by the operator through the headgear;

FIGS. 7 and 8 are block diagrams of other configurations of the system, according to various embodiments of the present disclosure; and

FIG. 9 is a flowchart of a method for displaying the machine information to the operator.

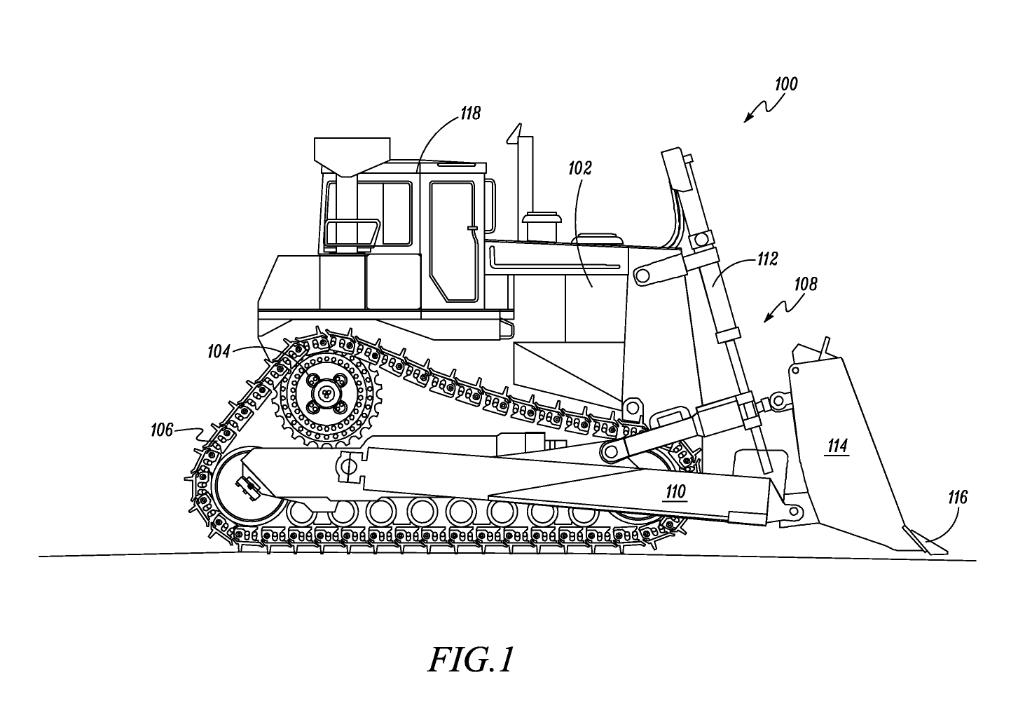

### DETAILED DESCRIPTION

Wherever possible, the same reference numbers will be used throughout the drawings to refer to the same or the like parts. FIG. 1 illustrates an exemplary machine 100 operating on a worksite according to one aspect of the present disclosure. As illustrated, the machine 100 may embody a track type tractor. Alternatively, the machine 100 may include a backhoe loader, a skid steer loader, a wheel loader, a motor grader, and the like. It should be understood that the machine 100 may embody any wheeled or tracked machine associated with mining, agriculture, forestry, construction, and other industrial applications.

As illustrated in FIG. 1, the machine 100 may include a power source 102, a transmission system (not shown), and a propulsion system 104. In one embodiment, the power source 102 may include, for example, a diesel engine, a gasoline engine, a gaseous fuel powered engine such as a natural gas engine, a combination of known sources of power or any other type of engine apparent to one of skill in the art. In the present embodiment, the power source 102 is disposed near a front section of the machine 100. Further, the transmission system of the machine 100 may be communicably coupled to the power source 102. The transmission system may include coupling elements for transmitting a drive torque from the power source 102 to the propulsion system 104. The propulsion system 104 may include a track 106 having ground engaging elements configured to propel the machine 100 on ground.

The machine 100 also includes a load lifting assembly 108 having a lift arm 110, one or more hydraulic actuators 112 and an implement 114. The implement 114, for example, a blade, a bucket or a ripper, may be present at a front end or rear end of the machine 100. In the illustrated embodiment, the implement 114 is a bucket and is provided at the front end of the machine 100. The bucket includes a cutting edge 116. The bucket is configured to collect, hold and convey material and/or heavy objects on the ground. The machine 100 includes an operator cabin 118. An operator command may be received through various input devices present within the operator cabin 118 of the machine 100. The hydraulic actuators 112 may be configured to effectuate a movement of the load lifting assembly 108 based on the operator command provided by the operator of the machine 100.

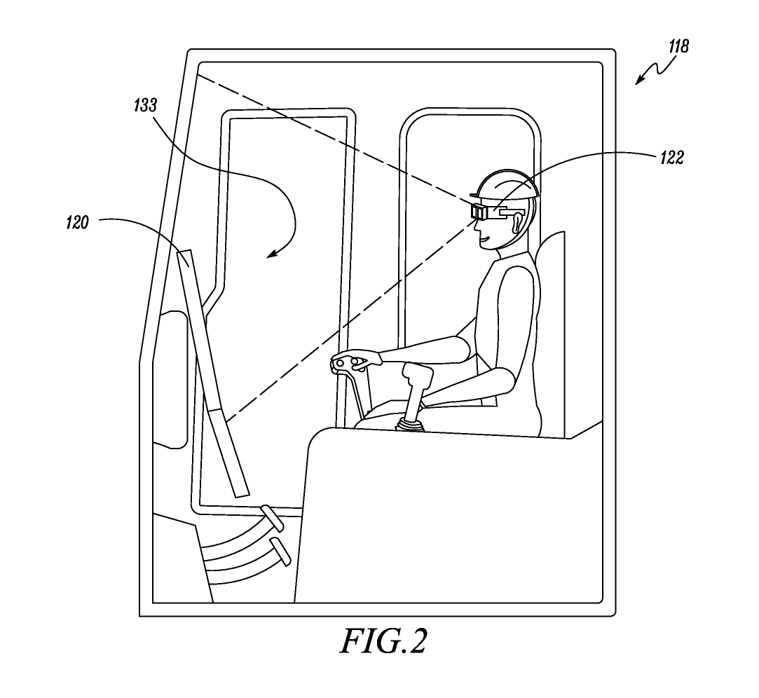

FIG. 2 shows an interior view of the operator cabin 118. The operator cabin 118 may include an instrument panel 120. The instrument panel 120 may include various controls and display panels for displaying the machine related information, such as, a machine speed, fuel usage, load on the implement 114, and so on. A headgear 122 is disclosed herein. The headgear 122 is configured to be worn by the operator, when seated within the operator cabin 118.

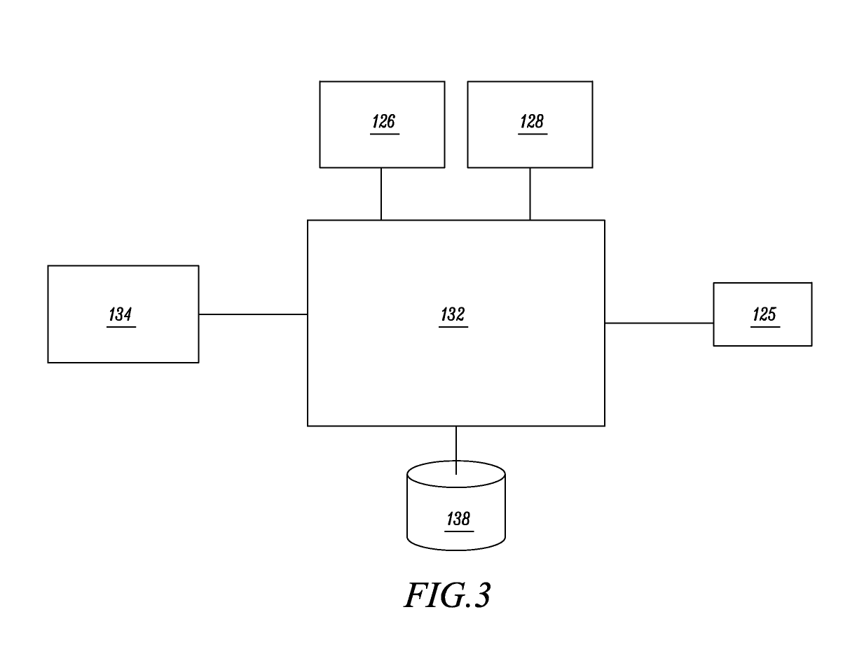

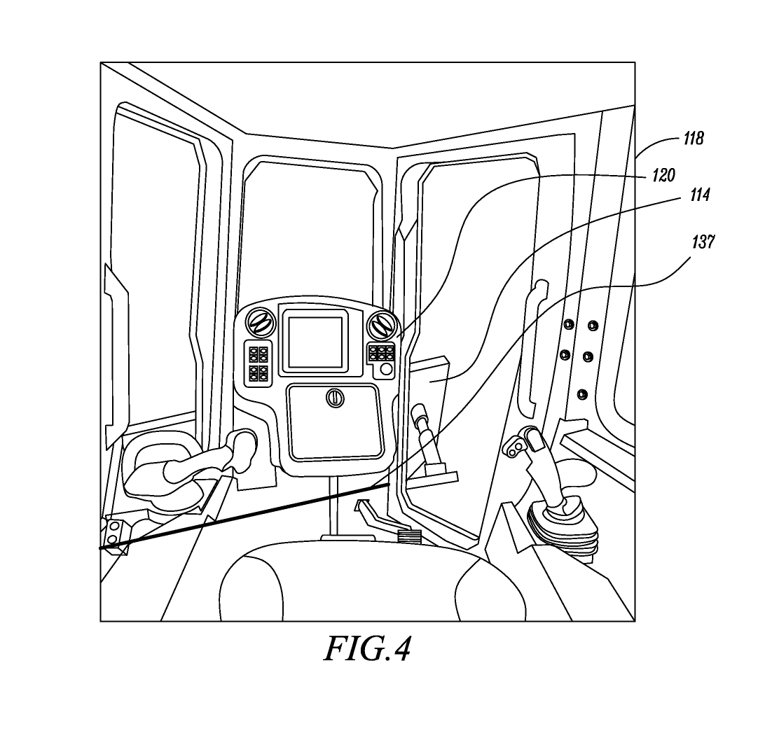

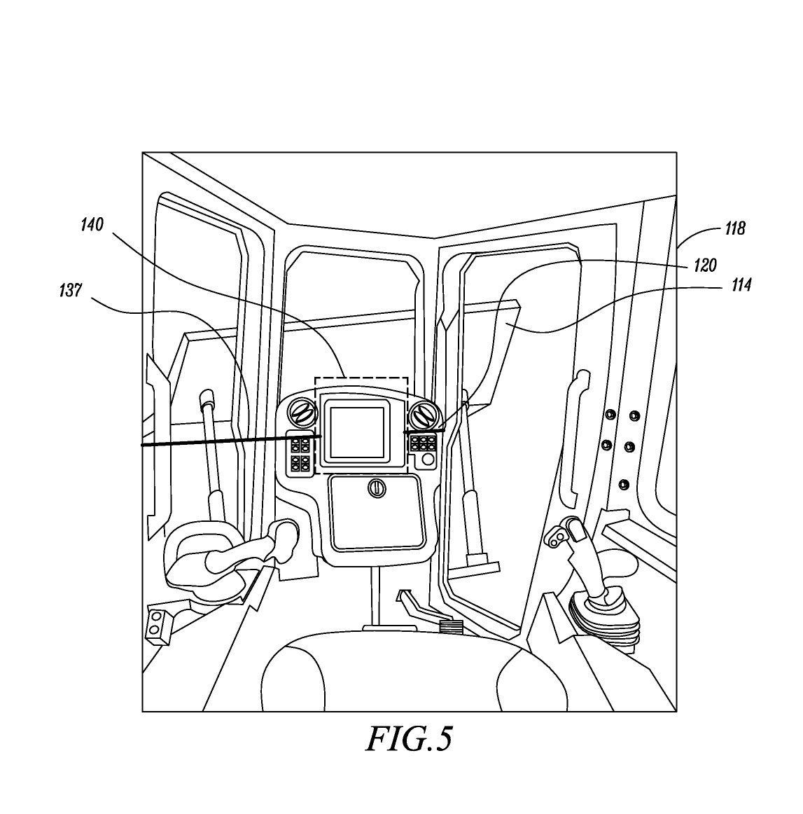

According to various embodiments of the present disclosure, the headgear 122 is configured to display thereon, information associated with the machine 100. The displays will be described in detail in connection with FIGS. 4 and 5. The headgear 122 may embody a wearable pair of glasses, a head mounted display, an EyeTap®, a virtual retinal display, or any other head mounted display known in the art. In the illustrated embodiment, the headgear 122 is the pair of glasses including lenses 125 affixed thereon. A tracking sensor 126 (see FIGS. 3, 6 and 7) and an image capturing device 128 (see FIGS. 3, 6 and 7) may be present on the headgear 122 configured to monitor and capture the operator's view within the operator cabin 118.

FIG. 3 illustrates a block diagram of the system for displaying the machine information associated with the headgear 122, according to one embodiment of the present disclosure. A first controller 132 is communicably coupled to the tracking sensor 126 and the image capturing device 128 of the headgear 122. The tracking sensor 126 is configured to generate a signal indicative of a direction of view of the operator. This tracking may take place on a real-time basis. The term “direction of view” used herein, refers to a direction in which the operator sitting within the operator cabin 118 of the machine 100 is looking, after wearing the headgear 122.

The tracking sensor 126 may determine the direction of view of the operator based upon a position of a head and/or an eye of the operator. Accordingly, the tracking sensor 126 may include a head tracking sensor and/or an eye tracking sensor respectively. The head tracking sensor may include, for example, a gyro sensor, an accelerometer, a magnetometer or any other known sensor. The eye tracking sensor may employ any known eye-attached tracking method, optical tracking or an electric potential measurement for tracking an eye movement of the operator. The tracking sensor 126 may be positioned on the headgear 122. For example, the gyro sensor is located on a frame of the headgear 122 worn by the operator.

The image capturing device 128 present on the headgear 122 may either have a fixed orientation or may be capable of movement with respect to the headgear 122. The tracking sensor 126 and the image capturing device 128 may be communicably coupled to the first controller 132. Based on the signals received from the tracking sensor 126 and the image capturing device 128, using any known image processing techniques, the first controller 132 may determine an image feed corresponding to a field of view 133 of the operator viewable through the lenses 125 of the headgear 122. The term “field of view” used herein refers to an extent of an observable world that includes a region present inside of the machine 100, machine components and a region outside of the machine 100, that is seen by the operator through the headgear 122, at any given moment while the operator is seated within the operator cabin 118. The image capturing device 128 may embody a camera or any other image or video recorder known in the art.

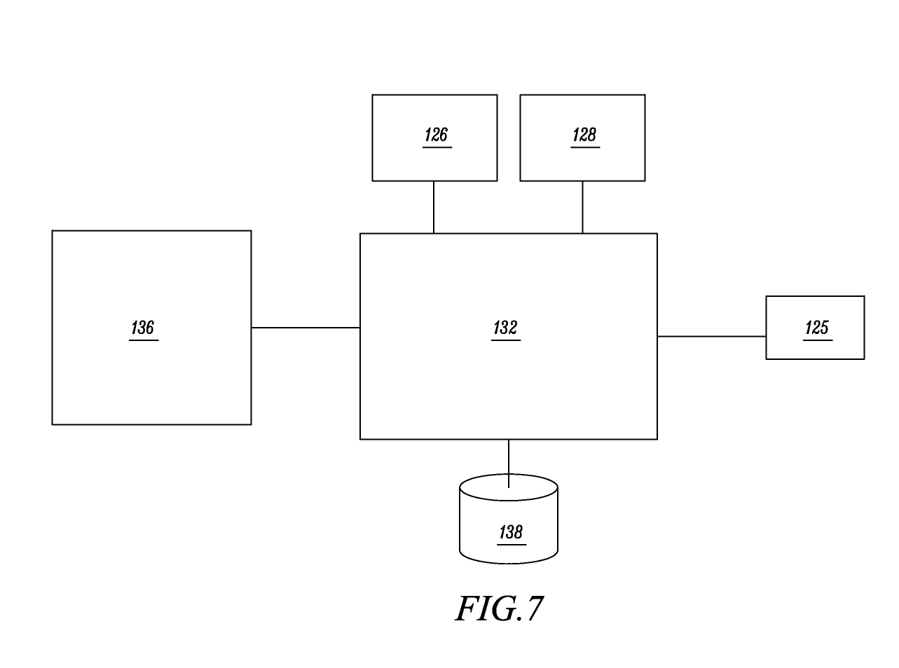

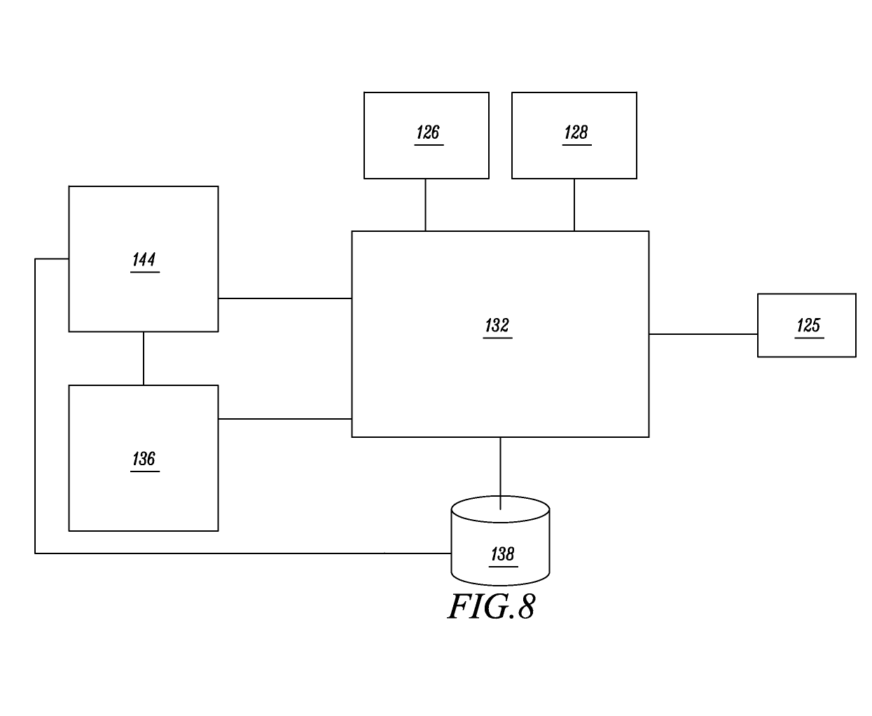

Referring to FIG. 3, the first controller 132 may be communicably coupled to an implement position detection module 134. The implement position detection module 134 is configured to generate a signal indicative of a current position of the implement 114. The implement position detection module 134 may include sensors to directly measure or determine the current position of the implement 114. Alternatively, the implement position detection module 134 may estimate or compute the current position of the implement 114 based on one or more measured signals. The implement position detection module 134 may include one or more of a position sensor, a pressure sensor, a flow sensor, an image sensor, a linkage sensor, a gear command sensor, and so on. In one embodiment, the implement position detection module 134 may include an electronic control module or a second controller 136 (see FIGS. 7 and 8) present on-board the machine 100. This electronic control module may be configured to control various machine functions. Detailed explanation of this configuration will be provided in connection with FIG. 7.

The first controller 132 is configured to receive the signal indicative of the current position of the implement 114 from the implement position detection module 134. Based on the current position of the implement 114, the first controller 132 is configured to overlay a first outline 137 (see FIG. 4) of at least a portion of the implement 114 onto the field of view 133 of the operator. For the track type tractor, the portion of the implement 114 may include for example, the cutting edge 116 of the bucket. The portion of the implement 114 may include any side, edge or surface of the implement 114 of interest to the operator based on the application.

The first controller 132 is configured to display at least a portion of the overlay on the headgear 122. More particularly, the display of the first outline 137 of the current position of the implement 114 may be shown on the lenses 125 of the headgear 122. FIG. 4 illustrates the display viewable to the operator through the lenses 125 of the headgear 122. The display includes a line segment representative of the first outline 137 which is overlaid or superimposed on the field of view 133 of the operator. The first outline 137 is indicative of the current position of the cutting edge 116 of the implement 114.

Referring to FIG. 3, in one embodiment, the first controller 132 is communicably coupled to a first database 138. The first database 138 is configured to store a pre-determined or expected position of the implement 114. This pre-determined position of the implement 114 may refer to a desired and/or an optimal position of the implement 114 in order to achieve an expected grade, slope and/or a cut on the worksite.

It should be noted that the machine 100 may perform one of several operations such as, cutting, digging, ground leveling and so on. In one example, wherein a cutting operation is to be performed by the implement 114 of the machine 100, the first database 138 may store the pre-determined position of the implement 114 that may be required in order to achieve the desired cut on the worksite. In this situation, the first controller 132 may be configured to compare the current position of the implement 114 with the pre-determined position required to achieve the desired cut. In another example, the machine 100 may be operated to achieve a desired grade with a particular slope on the worksite during a single pass of the machine 100 on the worksite or after multiple passes of the machine 100 on the worksite as the case may be. In this situation, the first database 138 may store a terrain map of the worksite on which the machine 100 is operating. Accordingly, the implement 114 of the machine 100 may need to be positioned at a particular angle relative to the worksite in order to achieve the desired grade and/or slope. The first database 138 may store the desired grade and/or slope to be achieved for the single pass or for various passes.

In this embodiment, the first controller 132 may be configured to retrieve the pre-determined position of the implement 114 from the first database 138. Further, the first controller 132 is configured to compare the current position of the implement 114 with the pre-determined position of the implement 114. Based on the comparison, the first controller 132 may determine if the current position of the implement 114 matches the pre-determined position of the implement 114 or not. In one embodiment, based on the comparison of the current position of the implement 114 with the pre-determined position of the implement 114, the first controller 132 may be configured to change an appearance of the first outline 137.

It should be noted that the change in appearance may include, for example the change in a line style, a color, brightness or a transparency associated with the first outline 137. This appearance of the first outline 137 on the lenses 125 of the headgear 122 may be changed based on a degree by which the current position of the implement 114 conforms to the pre-determined position of the implement 114. It should be noted that the current position of the implement 114 will conform to the pre-determined position, if the current position of the implement 114 lies at an identical location or lies within acceptable threshold limits of the pre-determined position of the implement 114. Also, the degree of conformity may be indicative of an extent of how close or far away the current position of the implement 114 is from that of the pre-determined position of the implement 114.

For example, in the track type tractor, when the current position of the cutting edge 116 is in conformity with the pre-determined position, the cutting edge 116 is represented by a solid green line on the lenses 125 of the headgear 122. In another example, when the current position of the cutting edge 116 is not in conformity with the pre-determined position, the cutting edge 116 is represented as a red colored dashed line. In yet another example, when the current position of the cutting edge 116 lies close to the pre-determined position, the cutting edge 116 may be represented as a yellow colored dashed line. Accordingly, based on the appearance of the first outline 137, the operator may be informed as to how close the current position of the implement 114 is from that of the pre-determined position of the implement 114.

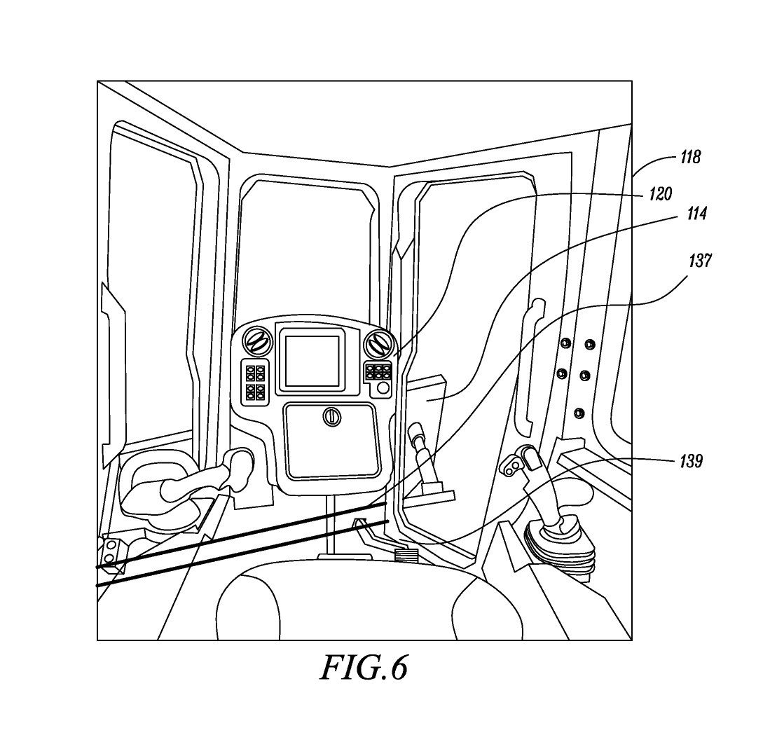

It should be noted that the displays disclosed herein are exemplary and do not limit the scope of the present disclosure. In one embodiment, as shown in FIG. 6, in addition to the first outline 137, the first controller 132 may be configured to display a second outline 139. The first outline 137 may be indicative of the current position of the implement 114, whereas the second outline 139 may be indicative of the pre-determined position of the implement 114. In one embodiment, wherein the first and second outlines 137, 139 differ in position on the display, a novice operator may accordingly operate the implement 114 of the machine 100 until the first outline 137 may coincide with the second outline 139 so that the current position of the implement 114 may reach the pre-determined position of the implement 114.

The display provided by the headgear 122 may also be used to coach the novice operator. Referring to FIG. 3, the first controller 132 may be configured to determine an operation that the operator is trying to perform. Accordingly, in one example, signals indicative of the operation being performed may be received by the first controller 132 by inputs received from the operator seated within the operator cabin 118. Alternatively, signals may be sent to the first controller 132 by sensors associated with the implement 114 of the machine 100. Further, based upon the determined operation, the first controller 132 may overlay the desired or expected position of the implement 114 and also the current position of the implement 114 on the headgear 122. A deviation of the current position of the implement 114 from that of the expected position of the implement 114 may be used to coach the operator so that the operator can accordingly maneuver the implement 114 to carry out the operation.

In some embodiments, the first database 138 may store information related to one or more restricted zones 140 within the operator cabin 118. Referring to FIG. 5, the restricted zones 140 within the operator cabin 118 may include those regions or areas within the operator cabin 118 in which the overlay on the lenses 125 should not be displayed. For example, machine related information, such as machine speed, fuel usage and navigation information may be displayed on the instrument panel 120 of the operator cabin 118. This instrument panel 120 may lie within the restricted zone 140, such that the first outline 137 of the cutting edge 116 should not be displayed over the machine information on the lenses 125 of the headgear 122.

The restricted zones 140 present within the operator cabin 118 may be determined in a number of ways. In one embodiment, the first database 138 may be configured to store information related to the restricted zones 140 present within the operator cabin 118. The first controller 132 may retrieve the information related to the restricted zone 140 from the first database 138 based on the direction of view of the operator and a position of the first outline 137 on the field of view 133 of the operator.

In another embodiment, the first controller 132 may be configured to determine the restricted zones 140 within the operator cabin 118. The first controller 132 may detect the presence of a display indicative of the instrument panel 120 on the image feed received from the image capturing device 128. The first controller 132 may detect features of the display of the instrument panel 120 using any of the known object recognition methods. Accordingly, based on the detection of the features of the display, the first controller 132 may detect the presence and position of the instrument panel 120 within the operator cabin 118, and accordingly identify the position of the restricted zone 140 therefrom. It should be noted that other methods of identification of the restricted zone 140 may be adopted without any limitation. Further, the presence and the position of the restricted zones 140 within the operator cabin 118 may vary based on the design of the operator cabin 118.

Further the first controller 132 may be configured to identify the portion of the first outline 137 that falls outside of the restricted zone 140. Accordingly, as shown in FIG. 5, the first controller 132 may be configured to display the portion of the first outline 137 which falls outside of the restricted zone 140. The first outline 137 of the cutting edge 116 is shown as a discontinuous line segment. A portion of the first outline 137 of the cutting edge 116 that falls within the restricted zone 140 containing the instrument panel 120 is omitted on the display viewable to the operator on the lenses 125 of the headgear 122. Based on the identification by the first controller 132, the first outline 137 of the cutting edge 116 displayed on the lenses 125 indicates the current position of the cutting edge 116 without overlapping the relevant machine information on the instrument panel 120 that lies in the restricted zone 140.

The first and second outlines 137, 139 displayed on the headgear 122 may be switched on and off as per requirements of the system. In one embodiment, the display may be switched on and off manually by the operator of the machine 100. For example, when the current position of the cutting edge 116 is such that the cutting edge 116 is visible to the operator from the operator cabin 118 or when the implement 114 is stationary, the display of the headgear 122 may be switched off. In an alternate embodiment, the first controller 132 may be configured to switch on/off the display, based on certain parameters associated with the machine 100, as will be explained in connection with FIG. 7.

FIG. 7 is a block diagram of another configuration of the system, according to one embodiment of the present disclosure. The second controller 136 may be communicably coupled to the first controller 132. The second controller 136 may be located on-board the machine 100. The second controller 136 may be configured to generate a signal indicative of one or more parameters associated with the machine 100. Further, the one or more parameters associated with the machine 100 may include at least one of a speed of the machine 100, a load associated with the implement 114, a location of the implement 114, the gear command, hydraulic pressure in cylinders, and the like.

The first controller 132 may be configured to receive the information related to the one or more parameters associated with the machine 100 from the second controller 136. The first database 138 may store thresholds corresponding to the one or more parameters of the machine 100. The first controller 132 is configured to retrieve the respective thresholds from the first database 138. The first controller 132 may compare the parameters of the machine 100 with the corresponding threshold value. Based on the comparison, the first controller 132 may switch on and off the display of the machine 100. For example, if the speed of the machine 100 exceeds the threshold limit, the first controller 132 may be configured to turn on or off the display as the case may be.

In some embodiments, the system may display information related to a surface of the worksite on which the machine 100 is operating. The information may include a terrain data or an object detection data relative to the worksite, as will be explained in connection with FIG. 8.

FIG. 8 is a block diagram of yet another exemplary implementation of the system. A third controller 144 may be communicably coupled to the first and second controllers 132, 136. In one embodiment, the third controller 144 may be located off-board the machine 100, for example, at a remote control station or a site managing office.

The third controller 144 may be communicably coupled to the first database 138. The first database 138 may be configured to store reference maps, geospatial information, and/or a historical data associated with the terrain of the worksite. Further, the first database 138 may also include position information related to various objects or obstacles present at the worksite, such as, presence of trenches, buried pipes, dugouts, loaded construction materials, boulders, and the like. Furthermore, the first database 138 may contain information related to a presence of various loading vehicles present at the worksite. The first controller 132 is configured to receive from the third controller 144 the surface information or object information associated with the worksite on which the machine 100 is operating.

In one embodiment, a machine position and orientation detection module (not shown) may be communicably coupled to the second controller 136. The machine position and orientation detection module may be configured to generate a signal indicative of a position and/or orientation of the machine 100 with respect to the worksite. The machine position and orientation detection module described herein, may be any one or a combination of a Global Positioning System, a Global Navigation Satellite System, a Pseudolite/Pseudo-Satellite, accelerometers, inclinometers or any other known position or orientation detection module known in the art.

The second controller 136 may receive the signal from the machine position and orientation detection module and transmit the signal to the third controller 144. Corresponding to the position and/or orientation of the machine 100 at the worksite, the third controller 144 may be configured to retrieve from the first database 138, at least a part of the surface information and/or the object information. More specifically, the part of the surface information and/or the object information retrieved may include the surface information and/or the object information associated with a region proximate to the position and/or orientation of the machine 100 at the worksite. The signal indicative of the surface information and/or the object information may be transmitted from the third controller 144 to the first controller 132.

Further, the first controller 132 may be configured to overlay the received surface and/or object information onto the field of view 133 of the operator. As described earlier an indicator of at least a portion of the received surface and/or object information falling within the field of view 133 of the operator may be overlaid and displayed on the headgear 122. For example, if an obstacle lies in proximity to the machine 100, and the current position of the obstacle relative to the machine 100 is obstructed, the indicator associated with the obstacle may be displayed on the lenses 125 of the headgear 122.

The communication between the first, second and/or third controllers 132, 136, 144 may take place through a same or different communication system. The communication system may be, but not limited to, a wide area network (WAN), a local area network (LAN), an Ethernet, Internet, an Intranet, a cellular network, a satellite network, or any other suitable network for transmitting the data. In various embodiments, the communication system may include a combination of two or more of the aforementioned networks and/or other types of networks known in the art. Further, the data transmission may occur over the communication system in an encrypted or otherwise secure format, in any of a wide variety of known manners.

It should be noted that the first database 138 described herein is on exemplary basis and does not limit the scope of the present disclosure. Also, the location of the first database 138 may vary based on the application. The data stored within the first database 138 may be procured from any source and updated on a real time basis. The first database 138 may be any conventional or non-conventional database known in the art. Moreover, the first database 138 may be capable of storing and/or modifying pre-stored data as per operational and design needs. The data distribution may vary based on the application and the system may additionally include other databases that are not shown herein

Numerous commercially available microprocessors may be configured to perform the functions of the first, second and/or third controllers 132, 136, 144. It should be appreciated that the first, second and/or third controllers 132, 136, 144 may readily embody a general machine microprocessor capable of controlling numerous machine functions. A person of ordinary skill in the art will appreciate that the first, second and/or third controllers 132, 136, 144 may additionally include other components and may also perform other functionality not described herein. It should be understood that the embodiments and the configurations and connections explained herein are merely on an exemplary basis and may not limit the scope and spirit of the disclosure.

### INDUSTRIAL APPLICABILITY

The operator of the machine 100 may need to be aware of the information associated with the machine 100, such as, the position of the implement 114 and/or the terrain information. The present disclosure relates to the headgear 122 worn by the operator within the operator cabin 118 of the machine 100. The overlay of the first outline 137, the second outline 139 and/or the indicator displayed on the headgear 122 may make the operator aware of the cutting edge 116 of the implement 114 and/or the surface and object information respectively which is otherwise obstructed from the operator's vision. Also, based on the appearance of the first and second outlines 137, 139, the operator may judge if the current position of the implement 114 conforms to the pre-stored metrics.

In one embodiment, the overlay of the first and/or second outlines 137, 139 displayed by the headgear 122 may assist the operator to achieve the expected cut, grade or slope. For example, the first controller 132 may be configured to indicate to the operator the current position of the implement 114 and also the expected or the pre-determined position of the implement 114. As described above, the pre-determined position of the implement 114 may be defined as the position of the implement 114 that is required to achieve the expected cut, grade or slope. The first controller 132 may also be configured to change the appearance of the first outline 137 visible to the operator. For example, based on the conformity of the current position of the implement 114 to the pre-determined position of the implement 114, the first outline 137 of the display may include a different color or style.

In another example, two outlines, namely the first and second outlines 137, 139 may be displayed by the headgear 122. The first outline 137 may indicate the current position of the implement 114, whereas the second outline 139 may be indicative of the expected position of the implement 114. Accordingly, the operator may be made aware of how close or far away the current position of the implement 114 is from that of the pre-determined position of the implement 114 based on the positioning of the first and second outlines 137, 139 respectively on the headgear 122.

Further, the display may also coach the novice operator in carrying out the machine operations. The first controller 132 may be configured to determine the operation that the operator is trying to perform. Accordingly, the first controller 132 may overlay and display the first and second outlines 137, 139 indicative of the current position of the implement 114 and the pre-determined position of the implement 114 respectively, based on the operation being performed. This may serve as a coaching to the novice operator for providing guidance to maneuver the implement 114 in an optimal manner in order to reach the pre-determined position based on the operation being performed.

Further, the headgear 122 is also configured to display the indicator of the surface and/or object information relative to the worksite on which the machine 100 is operating. For example, the first controller 132 may be configured to detect the presence of various objects on the worksite that may either be not visible to the operator as the object is underground, or the object is not viewable due to obstruction by parts of the machine 100. In one example, the display may be configured to detect the presence of objects buried within the ground. The objects may include buried pipes present underground. The display of the indicator on the headgear 122 may therefore make the operator aware of when the machine 100 is close proximity to the buried object. Thus, the operator may accordingly maneuver the implement 114 in order to avoid collision with such buried objects and also thereby prevent damage to the machine 100 and the pipe.

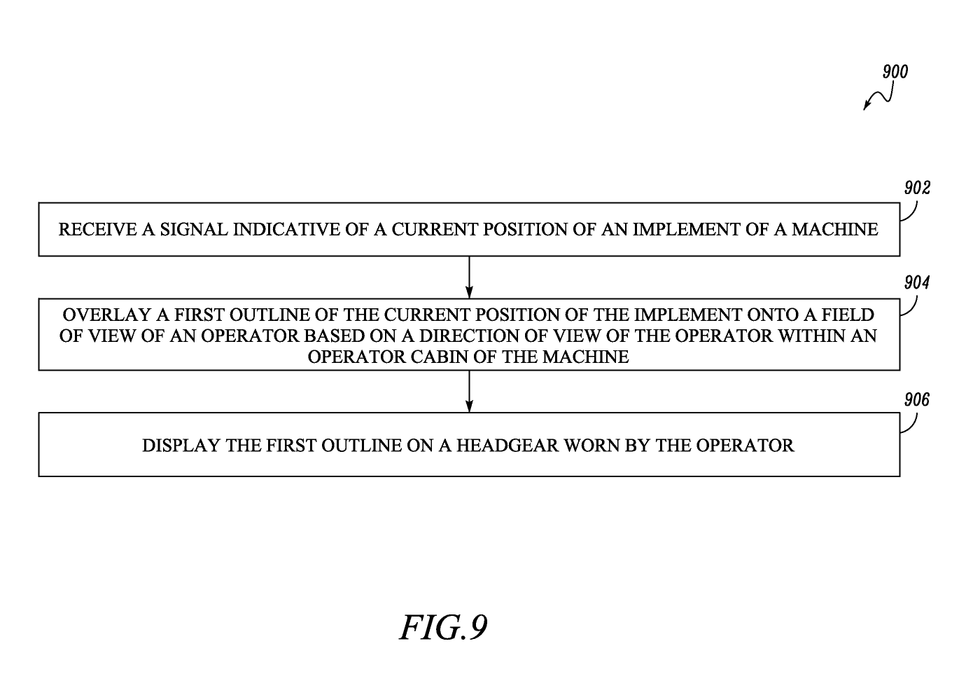

FIG. 9 is a flowchart for a method 900 of displaying information of the machine 100. At step 902, the first controller 132 may receive the signal indicative of the current position of the implement 114 of the machine 100. The signals may be received from the implement position detection module 134. In another embodiment, the signal may be received from the second controller 136.

At step 904, the first controller 132 is configured to overlay the first outline 137 of the current position of the implement 114 onto the field of view 133 of the operator. Based on the direction of view of the operator, the field of view 133 of the operator is received by the first controller 132 from the image capturing device 128. At step 906, the first controller 132 may be configured to display the first outline 137 of the portion of the implement 114 on the headgear 122 worn by the operator.

In one embodiment, the first controller 132 is configured to compare the current position of the implement 114 with the pre-determined position of the implement 114. Based on the comparison of the current with pre-determined positions of the implement 114, the first controller 132 may change the appearance of the first outline 137 on the display viewable by the operator. The change in appearance may include any of a change in the color, brightness or form of the first outline 137. Further, in another embodiment, the first controller 132 may be configured to overlay and display the first and second outlines 137, 139 on the headgear 122. In this embodiment, the second outline 139 may be indicative of the pre-determined position of the implement 114 so that the operator may be made aware of the degree of conformity of the current position of the implement 114 with that of the pre-determined position of the implement 114.

The restricted zones 140 may be defined within the operator cabin 118. The first controller 132 may determine the restricted zones 140 and identify the portion of the first outline 137, second outline 139 and/or the indicator that falls outside of the restricted zone 140. The first controller 132 may overlay those portions of the first outline 137, second outline 139 and/or the indicator on the display that falls outside of the restricted zone 140.

Further, the display may be activated by the input provided by the user. Alternatively, the display may be switched on and off based upon certain machine parameters. The signals indicative of the machine parameters may be received by the first controller 132. The parameters may include one of the speed of the machine 100, location of the implement 114, load associated with the implement 114 and/or the gear command. The first controller 132 may compare the signals with the respective thresholds. Based on the comparison, the display on the headgear 122 may be switched on or off as the case may be.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for displaying a position of an implement of a machine, the system comprising:
a headgear configured to be worn by an operator of the machine, the headgear comprising:
a tracking sensor configured to generate a signal indicative of a direction of view of the operator;
an image capturing device configured to generate an image feed indicative of a field of view of the operator; and
a first controller communicably coupled to the tracking sensor and the image capturing device, the first controller configured to:
receive a signal indicative of a current position of the implement of the machine;
overlay a first outline of the current position of the implement onto the field of view based on the direction of view of the operator; and
display the first outline on the headgear.

2. The system of claim 1, wherein the tracking sensor includes at least one of:
a head tracking sensor configured to generate a signal indicative of a position of a head of the operator; and
an eye tracking sensor configured to generate a signal indicative of a position of an eye of the operator.

3. The system of claim 1 further comprising:
a second controller communicably coupled to the first controller, the second controller located on-board the machine, wherein the second controller is configured to generate a signal indicative of one or more parameters associated with the machine.

4. The system of claim 3, wherein the one or more parameters includes at least one of a speed of the machine, a location of the implement, a load associated with the implement and a gear command.

5. The system of claim 3, wherein the first controller is further configured to:
receive the signal indicative of the one or more parameters associated with the machine;
compare the one or more parameters with respective thresholds; and
activate the display based on the comparison.

6. The system of claim 3, wherein the second controller is further configured to generate the signal indicative of the current position of the implement of the machine.

7. The system of claim 3 further comprising:
a third controller communicably coupled to the first controller and the second controller, the third controller located off-board the machine, the third controller configured to:
maintain a surface information and an object information associated with a worksite on which the machine is operating; and
transmit, to the first controller, a signal indicative of at least one of the surface information and the object information based on a position of the machine relative to the worksite.

8. The system of claim 7, wherein the first controller is further configured to:
receive the signal indicative of at least one of the surface information and the object information;
overlay an indicator of at least one of the surface information and the object information onto the field of view based on the direction of view of the operator; and
display the indicator on the headgear.

9. The system of claim 1, wherein the first controller is further configured to:
determine a restricted zone within an operator cabin;
identify a portion of the first outline that falls outside of the restricted zone; and
display the portion of the first outline on the headgear based on the identification.

10. The system of claim 1, wherein the first controller is further configured to:
compare the current position of the implement with a pre-determined position of the implement; and
change an appearance of the first outline based on the comparison.

11. The system of claim 10, wherein the appearance of the first outline includes at least one of a color and a brightness.

12. The system of claim 10, wherein the first controller is further configured to:
overlay a second outline of the pre-determined position of the implement; and
display the second outline on the headgear.

13. The system of claim 1, wherein the display is activated based on a user input.

14. A method comprising:
receiving a signal indicative of a current position of an Implement of a machine;
overlaying a first outline of the current position of the implement onto a field of view of an operator based on a direction of view of the operator within an operator cabin of the machine; and
displaying the first outline on a headgear worn by the operator.

15. The method of claim 14 further comprising:
determining a restricted zone within the operator cabin;
identifying the portion of the overlay that falls outside of the restricted zone; and
displaying the portion of the overlay on the headgear based on the identification.

16. The method of claim 14 further comprising:
comparing the current position of the implement with a pre-determined position of the implement; and
changing an appearance of the first outline based on the comparison.

17. The method of claim 16 further comprising:
overlaying a second outline of the pre-determined position of the implement; and
displaying the second outline on the headgear.

18. The method of claim 14 further comprising:
receiving a signal indicative of one or more parameters associated with the machine;
comparing the one or more parameters with respective thresholds; and
activating the display based on the comparison.

19. The method of claim 18, wherein the one or more parameters includes at least one of a speed of the machine, a location of the implement, a load associated with the implement and a gear command.

20. A headgear for an operator of a machine, the headgear comprising:
a tracking sensor configured to generate a signal indicative of a direction of view of the operator;
an image capturing device configured to generate an image feed indicative of a field of view of the operator; and
a first controller communicably coupled to the tracking sensor and the image capturing device, the first controller configured to:
receive a signal indicative of a current position of an implement of the machine;
overlay a first outline of the current position of the implement onto the field of view based on the direction of view of the operator; and
display the first outline on the headgear.
